(19) United States
(12) Patent Application Publication
(10) Pub. No.: US 2003/0012429 A1
(43) Pub. Date: Jan. 16, 2003

(54) Automatic determination method for color scanning mode of scanner

(76) Inventor: Kuo-Jeng Wang, Kaohsiung (TW)

Correspondence Address: J.C. Patents, Inc., Suite 114, 1340 Reynolds Ave., Irvine, CA, 92614, US

(21) Appl. No.: 09/898,610

(22) Filed: Jul. 3, 2001

(51) Int. Cl. G06K 9/00

(52) U.S. Cl. 382/165

(57) ABSTRACT

An automatic determination method for color scan of a scanner. The previewed image data is analyzed for the determination method of the color, gray scale and black-and-white scan. Whether the image data is suitable for black-and-white scan is determined. When it is suitable, the black-and-white scan is executed. When it is not suitable, whether the image data is suitable for gray scale scan is judged. If it is suitable for gray scale scan, the gray scan is performed. If it is not suitable for the gray scale scan, a color scan is performed. Therefore, without manual configuration by the user, a reasonable correction scan can be determined.

### BACKGROUND OF THE INVENTION

1. Field of the Invention

The invention relates in general to an automatic determination method for a scanner, and more particularly, to an automatic determination method of the color scanning mode for a scanner.

2. Description of the Related Art

The computer has become an indispensable necessity of everyday life. As computers become more and more advanced, the techniques of multi-media have become better and better developed. Image processing has also improved, leading to the development of many computer peripheral image processors such as the scanner. In only a few years, the palm black-and-white scanner has developed into a full color high resolution scanner, which produces images of fine quality and fidelity.

In the past, when using a scanner, the user had to manually configure the scanning mode of the scanner. A lot of time was wasted configuring the scanning mode, making the application of the scanner very inconvenient.

### SUMMARY OF THE INVENTION

The invention provides an automatic determination method of color scanning mode for a scanner. The previewed image data is analyzed to determine which scanning mode is appropriate. A scanning operation is performed according to the determined result. Therefore, without manual configuration by the user, a reasonable and correct scanning mode can be determined.

The automatic determination method of color scanning mode for a scanner includes the following steps. Image data previewed by the scanner is used to determine whether a black-and-white scanning mode is suitable. If it is suitable, the black-and-white scan is performed, if not, it is determined whether the gray scale scanning mode is suitable. If so, the gray scan is performed, if not, the color scan is performed.

In one embodiment of the invention, while determining whether the black-and-white scanning mode is suitable, the pixel of the previewed image data is divided into a low brightness area and a high brightness area. A low brightness mean value and a low brightness standard deviation are calculated from the low brightness area, and a high brightness mean value and a high brightness standard deviation are calculated from the high brightness area. When the low brightness mean value and standard deviation are smaller than a predetermined low brightness mean value and standard deviation, and the high brightness mean value is greater than a predetermined high brighteness mean value and the standard deviation is smaller than a predetermined standard deviation, the black-and-white scan is performed.

In the automatic determination method of color scanning mode in the above embodiment, a formula

$${E}_{total} = {\sum }_{m = 0}^{m = n - 1} [ {\sum }_{x = R , G , B} \vert {L}_{x} - L \vert / 3 ]$$

can be used to determine whether a gray scale scan is appropriate. In this formula, L=(L_{R}+L_{G}+L_{B}), L_{R} indicates the brightness of the red color, L_{G} indicates the brightness of the green color, and L_{B} indicates the brightness of the blue color. The image data has n pixels. Each pixel has a different brightness for red color (L_{R}), green color (L_{G}), and blue color (L_{B}). When the average displacement of the red, green and blue colors for the n pixels (Eₜₒₜₐₗ) is smaller than a predetermined value (Eᵣ), the gray scale scan is performed. When Eₜₒₜₐₗ>Eᵣ, the color scan is performed.

By being able to analyze the previewed image data, the invention can automatically determine the suitable scanning mode.

Both the foregoing general description and the following detailed description are exemplary and explanatory only and are not restrictive of the invention, as claimed.

### BRIEF DESCRIPTION OF THE DRAWINGS

FIG. 1 shows a color scanning mode determination method of a scanner according to the invention;

FIG. 2 shows the method illustrated in FIG. 1, in which it is determined whether a black-and-white scanning mode is suitable; and

FIG. 3 shows the method illustrated in FIG. 1, in which it is determined whether a gray scanning mode is suitable.

### DESCRIPTION OF THE PREFERRED EMBODIMENTS

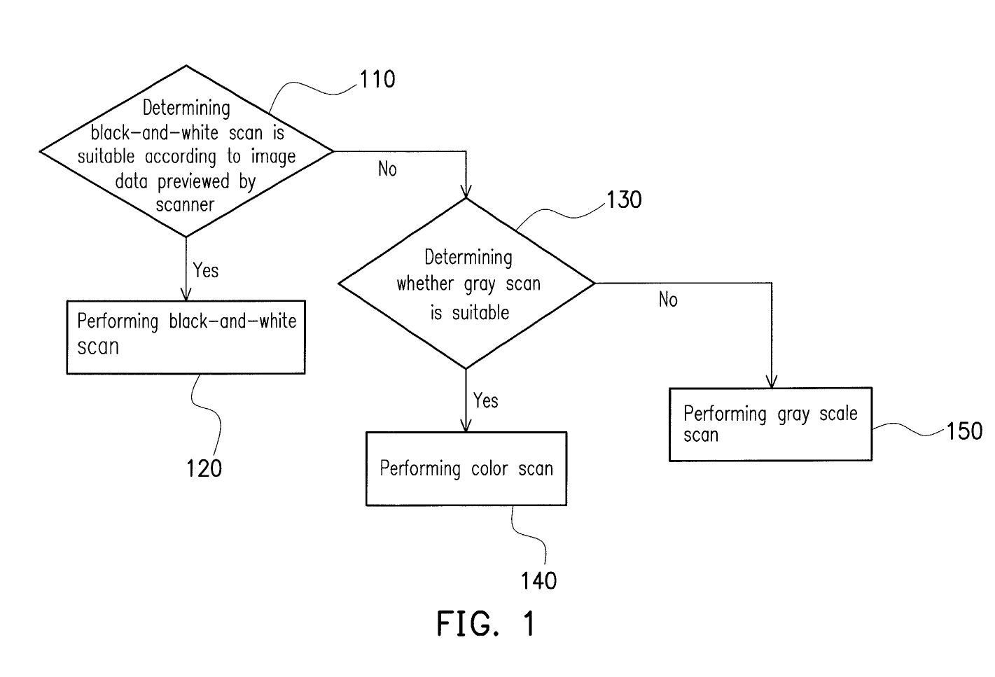

In FIG. 1, an embodiment of an automatic determination method for color scanning mode of a scanner is shown. According to image data previewed by the scanner, in step 110 it is determined whether a black-and-white scanning mode is suitable. When the black-and-white scanning mode is suitable, the black-and-white scan is performed in step 120. When the black-and-white scanning mode is not suitable, in step 140 it is determined whether the gray scale scanning mode is suitable. When the gray scale scanning mode is not suitable, the color scan is performed in step 150.

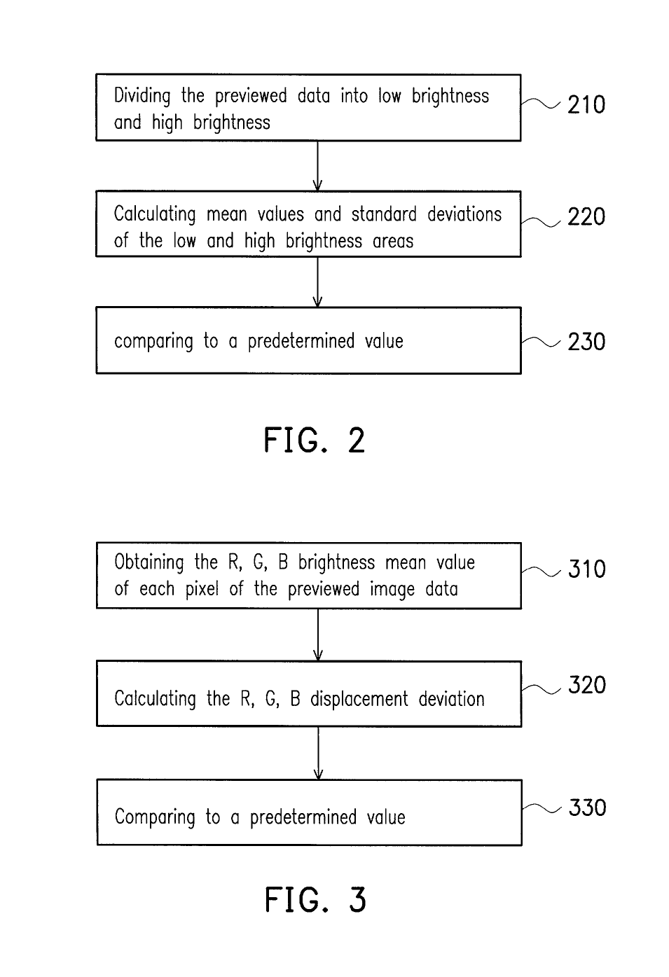

Referring to FIG. 1 and FIG. 2, a method to determine whether the black-and-white scanning mode is suitable is shown. The previewed image data is divided into a low brightness area and a high brightness area in step 210. The brightness range of the low brightness range is about 0-127, while the brightness range of the high brightness range is about 128-255. The mean values and standard deviations of the low and high brightness areas are calculated in step 220. That is, the low brightness mean value mean A and the standard deviation standard deviation A are calculated from the low brightness area, and the high brightness mean value mean B and the standard deviation standard deviation B are calculated from the high brightness area. The mean values and standard deviations are compared to predetermined values in step 230. When the low brightness mean value mean A and standard deviation standard deviation A are smaller than the predetermined low brightness mean value mA and standard deviation sA, and the high brightness mean value mean B is larger than the predetermined high brightness mean value mB, and the standard deviation standard deviation B is smaller than the predetermined standard deviation sB, the black-and-white scanning mode is appropriate. The black-and-white scan is then performed in step 120. When mean A>mA, standard deviation A>sA, mean B>mB, and standard deviation B>sB, the black-and-white scanning mode is not suitable. Whether the gray scale scanning mode is suitable is determined in step 130.

Referring to FIGS. 1 and 3, the method to determine whether the gray scale scanning mode is appropriate is shown. In FIG. 3, an average brightness of the R, G, B colors for each pixel of the previewed image data is obtained in step 310. This step can be presented as:

L=(L_{R}+L_{G}+L_{B})/3

L_{R} is the brightness of the primary red color, L_{G} is the brightness of the primary green color, and L_{B} is the brightness of the primary blue color. The previewed image data has n pixels, the brightness of different primary colors of each pixel is denoted by L_{R}, L_{G}, L_{B}, and L is the average of these three values for each pixel. The displacement of the pixels is then calculated in step 320. A mathematical formula

$${E}_{total} = {\sum }_{m = 0}^{m = n - 1} [ {\sum }_{x = R , G , B} \vert {L}_{x} - L \vert / 3 ]$$

is used to calculate the total brightness displacement Eₜₒₜₐₗ of the red, green and blue colors for n pixels. The total brightness displacement Eₜₒₜₐₗ is compared to the predetermined value Eᵣ in step 330. When Eₜₒₜₐₗ>Eᵣ, the gray scale scanning mode is suitable, so that the gray scan is performed in step 140. If Eₜₒₜₐₗ>Eᵣ, the gray scanning mode is not suitable, and the color scan is performed in step 150. n is a positive integer number larger than 1. The above formula can also be L=L_{R}+L_{G}+L_{B} and

$${E}_{total} = {\sum }_{m = 0}^{m = n - 1} [ {\sum }_{x = R , G , B} \vert {L}_{x} - L \vert ] .$$

Though the values are not the same, the determination can also be achieved.

The invention thus has the advantage that the scan mode is automatically determined. The user does not have to judge the correct scan mode of the scanner by himself/herself.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

What is claimed is:

1. A method of automatic determination of a color scanning mode for a scanner, comprising:
determining whether a black-and-white scanning mode is appropriate according to an image data previewed by the scanner;
performing a black-and-white scan when the black-and-white scanning mode is appropriate;
determining whether a gray scale scanning mode is appropriate when the black-and-white scanning mode is not the appropriate scanning mode;
performing a gray scale scan when the gray scale scanning mode is the appropriate scanning mode; and
performing a color scan when the gray scanning mode is not the appropriate scanning mode.

2. The method according to claim 1, the step of determining whether the black-and-white scanning mode is appropriate further comprising:
dividing pixels of the image data into a low brightness area and a high brightness area;
calculating a low brightness mean value and a low brightness standard deviation from the low brightness area;
calculating a high brightness mean value and a high brightness standard deviation from the high brightness area; and
when the low brightness mean value and standard deviation are smaller than predetermined low brightness mean value and standard deviation, the high brightness mean value is larger than a predetermined high brightness mean value, and the high brightness standard deviation is smaller than a predetermined high brightness standard deviation, the black-and-white scanning mode is appropriate.

3. The method according to claim 1, the step of determining whether the gray scale scanning mode is appropriate further comprising:
obtaining a brightness sum of a red color brightness, a green color brightness, and a blue color brightness of a plurality of pixels obtained by a preview scan;
obtaining a brightness displacement by calculating a sum of an absolute value of deducting the red color brightness with the brightness sum, an absolute value of deducting the green color brightness with the brightness sum, and an absolute value of deducting the blue color brightness with the brightness sum for each pixel;
adding the brightness displacements of all the pixels to obtain a total red, green, and blue brightness displacement; and
performing a gray scan when the total red, green, and blue brightness displacement is smaller than a predetermined red, green, and blue brightness displacement of the scanner.

4. The method according to claim 3, wherein the red, green and blue brightness of each of the pixels is obtained from the total red, green, and blue brightness divided by 3, and the total of the red, green and blue brightness displacement of the pixels is obtained by summing together each red, green, and blue brightness displacement divided by 3, and when the total red, green and blue brightness displacement is smaller than a predetermined displacement value, the scanning mode is changed to a gray scale scanning mode.
